(19) United States
(12) Patent Application Publication
(10) Pub. No.: US 2025/0033112 A1
(43) Pub. Date: Jan. 30, 2025

(54) METHOD AND APPARATUS FOR FORMING INTERNAL STRUCTURES OF THREE-DIMENSIONAL (3D) OBJECTS

(71) Applicant: XEROX CORPORATION, NORWALK, CT (US)

(72) Inventors: PriyaankaDevi Guggilapu, Durham, NC (US); David A. Mantell, Rochester, NY (US); Schuyler Kylstra, Chapel Hill, NC (US); Madhav Gentela, Cary, NC (US)

(73) Assignee: XEROX CORPORATION, NORWALK, CT (US)

(21) Appl. No.: 18/358,369

(22) Filed: Jul. 25, 2023

(51) Int. Cl. B22D 23/00; B33Y 10/00; B33Y 30/00; B33Y 50/02

(52) U.S. Cl. CPC B22D 23/003; B22F 10/85; B22F 12/53; B33Y 10/00; B33Y 30/00; B33Y 50/02

(57) ABSTRACT

A method of operating a printer to fill an internal volume of a three-dimensional object is includes determining a total number of layers required to fill an internal volume of a three-dimensional object, forming at least one floor layer within the internal volume, using a maximum individual stepout distance to generate machine-ready instructions that operate the printer to form one or more pre-determined sloped edges of a plurality of sections of a sparse infill structure in the layer of the internal volume to be filled, thereby forming at least one sparse infill layer. A drop ejecting apparatus includes a controller operatively connected to a reservoir, an ejector, and at least one actuator, the controller being configured to perform the method as described herein.

### TECHNICAL FIELD

The present teachings relate generally to three-dimensional (3D) object printers that eject melted metal drops to form objects and, more particularly, to more efficient printing methods for forming three-dimensional parts.

### BACKGROUND

A drop-on-demand (DOD) or three-dimensional (3D) printer builds (e.g., prints) a 3D object from a computer-aided design (CAD) model, usually by successively depositing material layer upon layer. A drop-on-demand (DOD) printer, for example, one that prints a metal or metal alloy, ejects a small drop of liquid aluminum alloy when a firing pulse is applied. Using this technology or others using various printing materials, a 3D part can be created by ejecting a series of drops which bond together to form a continuous part. For example, a first layer may be deposited upon a substrate, and then a second layer may be deposited upon the first layer. One particular type of 3D printer is a magnetohydrodynamic (MHD) printer, which is suitable for jetting liquid metal layer upon layer which bond together to form a 3D metallic object. Magnetohydrodynamic refers to the study of the magnetic properties and the behavior of electrically conducting fluids.

Furthermore, 3D printing technology is well known for enabling the manufacture of complex 3D designs which otherwise could not be made using traditional methods such as machining, casting, or injection molding. This ability is made possible through a common trait that all the 3D printing processes share, which is to divide a given geometry along the printing direction into multiple two-dimensional (2D) layers and print one layer at a time. In this approach, larger parts can be prohibitive due to heavier weight of parts due to the fill portion on the interior portions of a 3D printed object or part.

Thus, a method of and apparatus for printing solid objects in a drop-on-demand or 3D printer is needed to produce 3D printed parts with reduced build time, reduced part cost and material use, and reduced weight.

### SUMMARY

The following presents a simplified summary in order to provide a basic understanding of some aspects of one or more embodiments of the present teachings. This summary is not an extensive overview, nor is it intended to identify key or critical elements of the present teachings, nor to delineate the scope of the disclosure. Rather, its primary purpose is merely to present one or more concepts in simplified form as a prelude to the detailed description presented later.

A method of operating a printer to fill an internal volume of a three-dimensional object is disclosed. The method includes determining a total number of layers required to fill an internal volume of a three-dimensional object. The method also includes forming at least one floor layer within the internal volume. The method also includes using a maximum individual stepout distance to generate machine-ready instructions that operate the printer to form one or more pre-determined sloped edges of a plurality of sections of a sparse infill structure in the layer of the internal volume to be filled. The method also includes forming at least one sparse infill layer. The method also includes forming at least one roof layer within the internal volume. The method also includes where the number of floor layers is the same as the number of roof layers.

Implementations of the method of operating a printer to fill an internal volume of a three-dimensional object may include where each sloped edge includes no support material. Each sloped edge angle can be from 15 degrees to 75 degrees. Each sloped edge angle can be 30 degrees. Each sloped edge angle can be 60 degrees. Each of the plurality of sections of the infill structure can have a lateral dimension of from about 5 mm to about 30 mm. Each of the plurality of sections of the infill structure can have a lateral dimension of 10 mm. The method of operating a printer to fill an internal volume of a three-dimensional object may include setting a number of floor layers to n, and setting a number of roof layers to n. A number of sparse infill layers may include determining the floor layers or the roof layers by subtracting 2n from the total number of layers. The layers required to fill an internal volume of a three-dimensional object may include a metal, a metallic alloy, or a combination thereof.

A drop ejecting apparatus is also disclosed. The drop ejecting apparatus includes a reservoir configured to receive and melt a print material. The drop ejecting apparatus also includes an ejector having a nozzle that is fluidly connected to the reservoir to receive melted print material from the reservoir and a platform positioned opposite the ejector. The drop ejecting apparatus also includes at least one actuator operatively connected to at least one of the platform and the ejector, the at least one actuator being configured to move the at least one of the platform and the ejector relative to one another. The drop ejecting apparatus also includes a controller operatively connected to the reservoir, the ejector, and the at least one actuator, the controller being configured to form at least one floor layer within an internal volume, use a maximum individual stepout distance to generate machine-ready instructions that operate the apparatus to form one or more pre-determined sloped edges of a plurality of sections of a sparse infill structure in the layer of the internal volume to be filled. The drop ejecting apparatus can further form at least one sparse infill layer, and form at least one roof layer within the internal volume. Implementations of drop ejecting apparatus can include where the number of floor layers is the same as the number of roof layers. The print material may include a metal, a metallic alloy, or a combination thereof. Each sloped edge can include no support material. Each sloped edge angle can be from 15 degrees to 75 degrees. Each sloped edge angle can be 30 degrees. Each sloped edge angle can be 60 degrees. Each of the plurality of sections of the infill structure can have a lateral dimension of from about 5 mm to about 30 mm. The controller is further configured to set a number of floor layers to n, and set a number of roof layers to n. A number of sparse infill layers may include having the floor layers or the roof layers determined by subtracting 2n from the total number of layers.

The features, functions, and advantages that have been discussed can be achieved independently in various implementations or can be combined in yet other implementations further details of which can be seen with reference to the following description.

### BRIEF DESCRIPTION OF THE DRAWINGS

The accompanying drawings, which are incorporated in and constitute a part of this specification, illustrate embodiments of the present teachings and together with the description, serve to explain the principles of the disclosure. In the figures:

FIG. 1 depicts a schematic cross-sectional view of a single liquid metal ejector jet of a 3D printer (e.g., a MHD printer and/or multi-jet printer), in accordance with the present disclosure.

FIGS. 2A and 2B depict various two-dimensional parameters comprising a sparse fill pattern for an internal volume in three-dimensional objects. FIGS. 2A and 2B depict a top view of a wall spacing and related parameters, in accordance with the present disclosure.

FIGS. 3A and 3B depict perspective views of sparse fill patterns for an internal volume in three-dimensional objects for a slope of 30 degrees and 60 degrees, respectively, in accordance with the present disclosure.

FIG. 4 depicts a top view of a typical fill pattern without the use of a sparse fill, in accordance with the present disclosure.

FIG. 5 illustrates a flowchart of a method for producing a sparse fill of an interior volume of a 3D object, in accordance with the present disclosure.

It should be noted that some details of the figures have been simplified and are drawn to facilitate understanding of the present teachings rather than to maintain strict structural accuracy, detail, and scale.

### DETAILED DESCRIPTION

Reference will now be made in detail to exemplary embodiments of the present teachings, examples of which are illustrated in the accompanying drawings. Wherever possible, the same reference numbers will be used throughout the drawings to refer to the same, similar, or like parts.

For the purpose of the present teachings, sparse fill can refer to a formation of metal that is produced in a lattice-type structure instead of regular 3D printed layers (solid infill). This results in segments of a 3D metal part being almost hollow, but with the support needed to retain strength and rigidity. The fill style only effects the interior of a 3D part, but the exterior looks the same as a solid fill part. The primary benefits of sparse fill include reduced build time, reduced part cost due to reduced material use, and reduced weight. Sparse fill can be used for larger scale parts having large interior structures where a three-dimensional part or object can benefit from having a reduced mass. This sparse fill pattern can be employed, for example, in the aerospace and automotive industry where light weight parts can provide crucial additions to fuel efficiency or reduced carbon footprint.

Examples of the present disclosure provide a printing system and approach that enables the printing of sparse fill or sparse infill within the interior volume of a three-dimensional part or object. Such methods of operating a printer to fill an internal volume of a three-dimensional object include determining a total number of layers required to fill an internal volume of a three-dimensional object, forming at least one floor layer within the internal volume, using a maximum individual stepout distance to generate machine-ready instructions that operate the printer to form one or more pre-determined sloped edges of a plurality of sections of a sparse infill structure in the layer of the internal volume to be filled, forming at least one sparse infill layer, and forming at least one roof layer within the internal volume. In examples, the number of floor layers is the same as the number of roof layers. The floor layers and roof layers provide a suitable transition from a solid portion of a three-dimensional object to a sparse infill interior volume and finally back to another solid portion of the three-dimensional object.

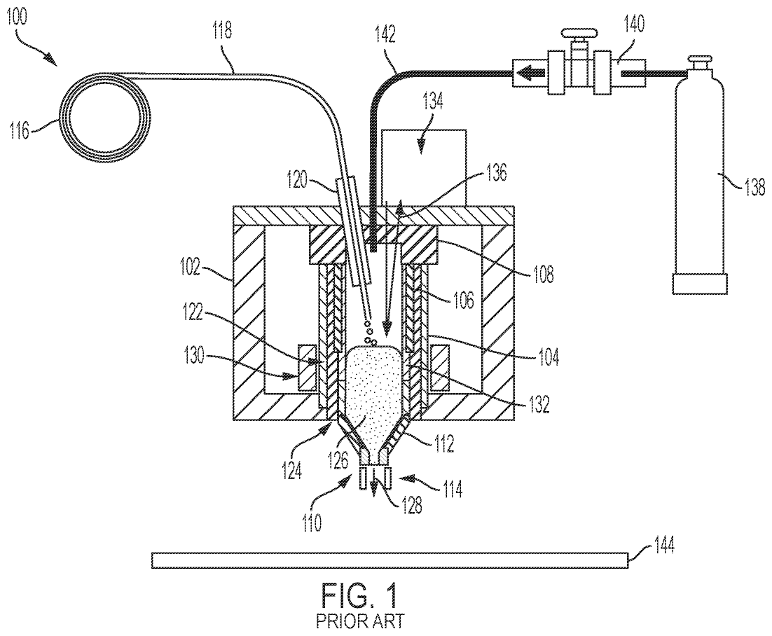

FIG. 1 depicts a schematic cross-sectional view of a single liquid metal ejector jet of a 3D printer (e.g., a MHD printer and/or multi-jet printer), in accordance with the present disclosure. FIG. 1 shows a portion of a type of drop-on-demand (DOD) or three-dimensional (3D) printer 100. The 3D printer or liquid ejector jet system 100 may include an ejector (also referred to as a body or pump chamber, or a “one-piece” pump) 104 within an outer ejector housing 102, also referred to as a lower block. The ejector 104 may define an inner volume 132 (also referred to as an internal cavity or an inner cavity). A printing material 126 may be introduced into the inner volume 132 of the ejector 104. This inner volume 132 may be considered a reservoir configured to receive and melt a print material within the inner volume 132 of the ejector 104. The printing material 126 may be or include a metal, a polymer, or the like. It should be noted that alternate jetting technology aside from MHD as described herein may be necessary depending on the nature and properties of the print material used in examples of the present disclosure. For example, the printing material 126 may be or include aluminum or aluminum alloy, introduced via a printing material supply 116 or spool of a printing material wire feed 118, in this case, an aluminum wire. The liquid ejector jet system 100 further includes a first inlet 120 within a pump cap or top cover portion 108 of the ejector 104 whereby the printing material wire feed 118 is introduced into the inner volume 132 of the ejector 104. The ejector 104 further defines a nozzle 110, an upper pump 122 area and a lower pump 124 area. One or more heating elements 112 are distributed around the pump chamber 104 to provide an elevated temperature source and maintain the printing material 126 in a molten state during printer operation. The heating elements 112 are configured to heat or melt the printing material wire feed 118, thereby changing the printing material wire feed 118 from a solid state to a liquid state (e.g., printing material 126) within the inner volume 132 of the ejector 104. The three-dimensional 3D printer 100 and ejector 104 may further include an air or argon shield 114 located near the nozzle 110, and a water coolant source 130 to further enable nozzle and/or ejector 104 temperature regulation. The liquid ejector jet system 100 further includes a level sensor 134 system which is configured to detect the level of molten printing material 126 inside the inner volume 132 of the ejector 104 by directing a detector beam 136 towards a surface of the printing material 126 inside the ejector 104 and reading the reflected detector beam 136 inside the level sensor 134.

The 3D printer 100 may also include a power source, not shown herein, and one or more metallic coils 106 enclosed in a pump heater that are wrapped at least partially around the ejector 104. The power source may be coupled to the coils 106 and configured to provide an electrical current to the coils 106. This electrical current can be provided as a pulse, which is delivered at a specific frequency, wherein the frequency determines a rate at which a pulse is delivered to the coils 106, and therefore how often a drop may be ejected from the ejector 104. An increasing magnetic field caused by the coils 106 may cause an electromotive force within the ejector 104, that in turn causes an induced electrical current in the printing material 126. The magnetic field and the induced electrical current in the printing material 126 may create a radially inward force on the printing material 126, known as a Lorenz force. The Lorenz force creates a pressure at an inlet of a nozzle 110 of the ejector 104. The pressure causes the printing material 126 to be jetted through the nozzle 110 in the form of one or more liquid drops 128.

The 3D printer 100 may also include a substrate 144, or platform that is positioned proximate to (e.g., below) the nozzle 110. The ejected drops 128 may land on the substrate 144 and solidify to produce a 3D object. The 3D printer 100 may also include a substrate control motor that is configured to move the substrate 144 while the drops 128 are being jetted through the nozzle 110, or during pauses between when the drops 128 are being jetted through the nozzle 110, to cause the 3D object to have the desired shape and size. The substrate control motor may be configured to move the substrate 144 in one dimension (e.g., along an X axis), in two dimensions (e.g., along the X axis and a Y axis), or in three dimensions (e.g., along the X axis, the Y axis, and a Z axis). In another example, the ejector 104 and/or the nozzle 110 may be also or instead be configured to move in one, two, or three dimensions. In other words, the substrate 144 may be moved under a stationary nozzle 110, or the nozzle 110 may be moved above a stationary substrate 144. In yet another example, there may be relative rotation between the nozzle 110 and the substrate 144 around one or two additional axes, such that there is four or five axis position control. In certain examples, both the nozzle 110 and the substrate 144 may move. For example, the substrate 144 may move in X and Y directions, while the nozzle 110 moves up and/or down in a Y direction. For the purposes of this disclosure, a print bed may also refer to the substrate.

The 3D printer 100 may also include one or more gas-controlling devices, which may be or include a gas source 138. The gas source 138 may be configured to introduce a gas. The gas may be or include an inert gas, such as helium, neon, argon, krypton, and/or xenon. In another example, the gas may be or include nitrogen. The gas may include less than about 10% oxygen, less than about 5% oxygen, or less than about 1% oxygen. In at least one example, the gas may be introduced via a gas line 142 which includes a gas regulator 140 configured to regulate the flow or flow rate of one or more gases introduced into the three-dimensional 3D printer 100 from the gas source 138. For example, the gas may be introduced at a location that is above the nozzle 110 and/or the heating element 112. This may allow the gas (e.g., argon) to form a shroud/sheath around the nozzle 110, the drops 128, the 3D object, and/or the substrate 144 to reduce/prevent the formation of oxide (e.g., aluminum oxide) in the form of an air shield 114. Controlling the temperature of the gas may also or instead help to control (e.g., minimize) the rate that the oxide formation occurs.

The liquid ejector jet system 100 may also include an enclosure 102 that defines an inner volume (also referred to as an atmosphere). In one example, the enclosure 102 may be hermetically sealed. In another example, the enclosure 102 may not be hermetically sealed. In one example, the ejector 104, the heating elements 112, the power source, the coils, the substrate 144, additional system elements, or a combination thereof may be positioned at least partially within the enclosure 102. In another example, the ejector 104, the heating elements 112, the power source, the coils, the substrate 144, additional system elements, or a combination thereof may be positioned at least partially outside of the enclosure 102. While the liquid ejector jet system 100 shown in FIG. 1 is representative of a typical liquid ejector jet system 100, locations and specific configurations and/or physical relationships of the various features may vary in alternate design examples.

Printing systems as described herein or printing systems having other print material feeds and/or ejection systems may alternatively include other printing materials such as plastics or other ductile materials that are non-metals. The print material can include a metal, a metallic alloy, or a combination thereof. A non-limiting example of a printing material can include aluminum. Exemplary examples of printing systems of the present disclosure can include an ejector for jetting a print material, including a structure defining an inner cavity, and a nozzle orifice in connection with the inner cavity and configured to eject one or more droplets of liquid print material, wherein the ejector is configured to form sparse infill patterns as described for a three-dimensional printed part.

In other known methods, printers such as those shown in FIG. 1 include a controller that is configured to receive instructions from a computing device or programmed set of coordinates to operate the ejector head to construct various elements of a 3D object. The reservoir or inner volume is configured to receive and melt a print material, while the ejector having a nozzle is fluidly connected to the reservoir to receive melted print material from the reservoir. As the platform is positioned opposite the ejector, at least one actuator operatively connected to at least one of the platform and the ejector is present, where the at least one actuator is configured to move the at least one of the platform and the ejector relative to one another. The controller is further operatively connected to the reservoir, the at least one ejector, and the at least one actuator, the controller being configured to perform various printing method instructions as described herein for producing sparse infill patterns for an internal volume of a three-dimensional object or part.

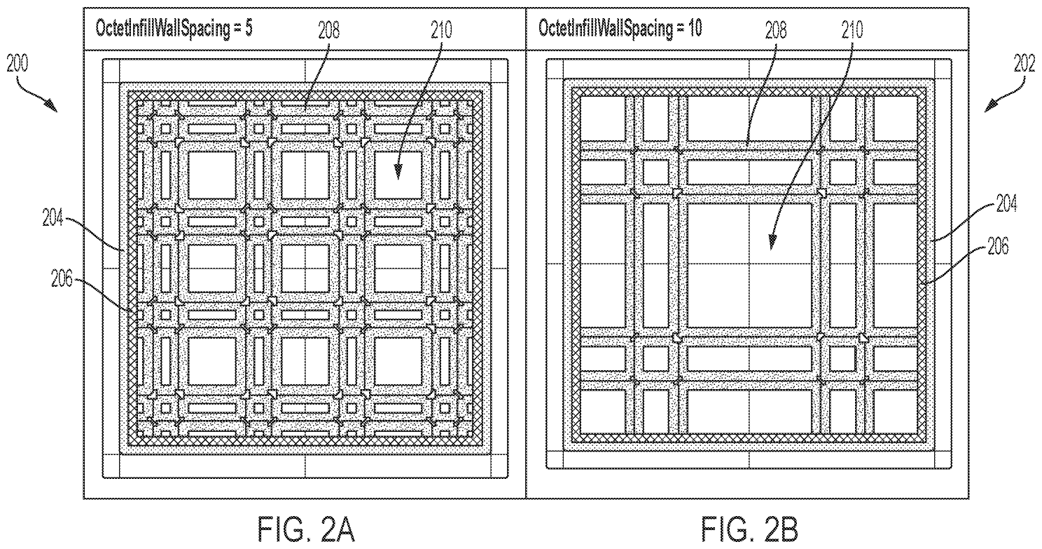

FIGS. 2A and 2B depict various two-dimensional parameters comprising a sparse fill pattern for an internal volume in three-dimensional objects. FIGS. 2A and 2B depict a top view of a wall spacing and related parameters, in accordance with the present disclosure. A top view of an internal volume 200 filled with a sparse infill pattern having a cell size of 5 mm (FIG. 2A) and a top view of an internal volume 202 filled with a sparse infill pattern having a cell size of 10 mm (FIG. 2B), also referred to as an octet pattern. This is referred to as an octet path or shape, based on the part shape, as each void is octahedral or is an octahedron. While that describes the basic structure, as it builds towards the external part surface, the octet based cells are trimmed, or can alternately be described as pyramid shapes, or interconnected truncated pyramidal shapes. The top view of each of the top views 200, 202 shown in FIGS. 2A and 2B each include an outer perimeter 204 for a three-dimensional part, an inner perimeter 206 for a three-dimensional part, one or more wall s 208 for each section, and an inner volume space 210 or sparse infill wall spacing, which reflects the size of the octet structure size. A sparse infill or fill toolpath (octet pattern) is formed by retaining similar build rules used for forming overhang structures with a metal drop ejecting 3D object printer. The sparse infill pattern includes 202 There are two main parameters that control the sparsity of infill. These include 1. Sparse fill wall spacing, and 2. Sparse fill slope. The sparse fill wall spacing 210 controls the nominal grid size or cell size of the octet pattern (in mm).

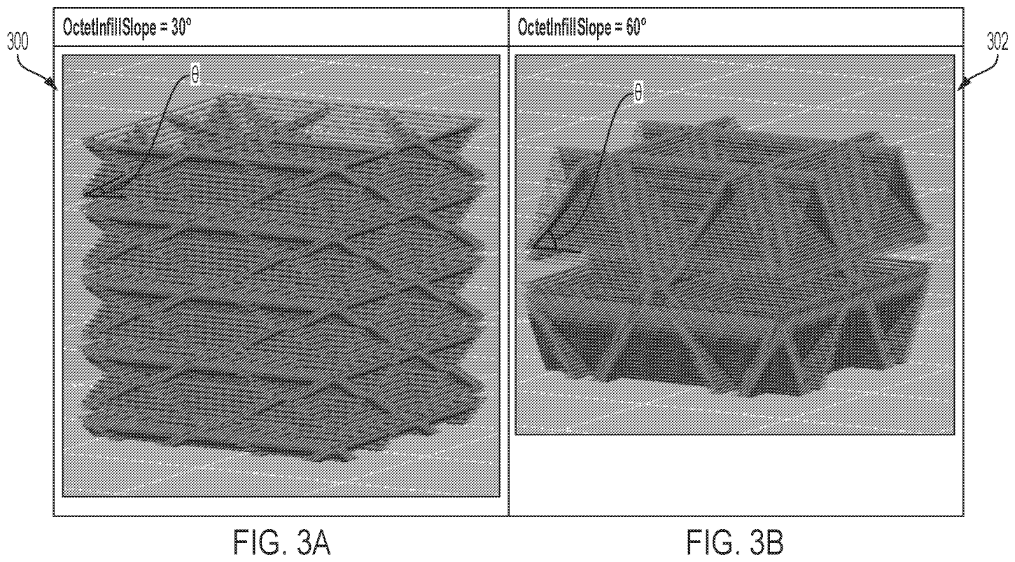

FIGS. 3A and 3B depict perspective views of sparse fill patterns for an internal volume in three-dimensional objects for a slope of 30 degrees and 60 degrees, respectively, in accordance with the present disclosure. An octet-based infill pattern having an overhang or sparse fill slope angle of 30° 300, and an octet-based infill pattern having an overhang angle of 60° 302 are each shown as examples of sparse infill patterns for supporting and filling an internal volume of a portion of a three-dimensional part. The sparse fill slope provides for a setting of the overhang angle, θ, of the fill pattern (in degrees). This overhang angle is defined relative to horizontal plane, such that lower values are more overhanging, higher values are less overhanging. This angle, θ, is used in the drop spacing calculation of the overhanging octet paths. Wall spacing or lateral dimensions between opposing walls and slope are directly proportional to the desired sparsity of the part. In examples, the pulse distance for the non-overhanging octet paths or non-overhanging structures in the octet fill pattern is set to 0.59 mm.

An additional component of the sparse infill pattern as described includes a transition or bridging from solid fill to sparse fill and back to solid fill. In examples, some internal volume areas may have only floor layers of solid fill, only roof, or alternatively both floor layers and roof layers. When enclosing the top and/or bottom of a part to form a dense fill structure requires bridging the sparse fill to form a solid fill. In exemplary cases, only the top is bridged. This is done by specifying the floor and roof layers. Floor layers determine the number of layers that needs to be solid fill before starting the sparse fill structure. Roof layers determine the number of layers from the topmost layer where sparse fill bridges to solid fill. In examples, both of these values are set to 3. Therefore, for a part with a total of 30 layers when generating the octet fill pattern (sparse infill pattern or infill pattern comprised of a plurality of sparse infill layers) with 3 floor layers and 3 roof layers, the first three layers is comprised of solid infill. layers from 4-26 are sparse fill pattern layers, and layers 27-30 comprises a solid fill pattern. At layer 27, the voids generated by the sparse fill located in between the walls of the cells are located and are filled before printing the solid pattern. A sparse infill layer is one of a plurality of middle layers of the overall infill structure that fills an internal volume of a 3D part. For a sparse infill structure to be printed or deposited to fill an internal void in a part, it bridges from one or more solid layers, for example, three layers of solid fill in the bottom (floor) of the volume, then transitions to the sparse infill pattern shown in FIGS. 3A and 3B, then back to three layers of solid fill in the top (roof) of the volume. Each layer in the sparse fill structure would comprise a sparse fill layer in this overall structure.

It should be noted that ranges of floor layers, roof layers, and sparse infill layers can be dependent on the size of the part and the drops of print material produced by the printer, and not limited by the exemplary description above. Likewise, the cell size or grid size may range from about 5 mm to about 30 mm, or from about 5 mm to about 20 mm, or from about 5 mm to about 10 mm. In exemplary examples, the cell size is dependent on the geometry of the part and the target density of the object or part. This method or system for practicing the method can be utilized in any 3D printing technology using any print material including, but not limited to metal or metal alloys, such as aluminum, copper, or alloys thereof, and other metals. In further examples, as the layer proceeds in a z or vertical direction, the cell size is decreased, resulting in conical or tetrahedral shaped cells. In other examples, this results as a gradual fill in each cell as z increases. It should further be noted that different parts or portions of built parts can have different requirements. When the cell size is reduced according to part geometry, such as height, size, location, etc., this can be a function of desired or required strength and shape and geometry.

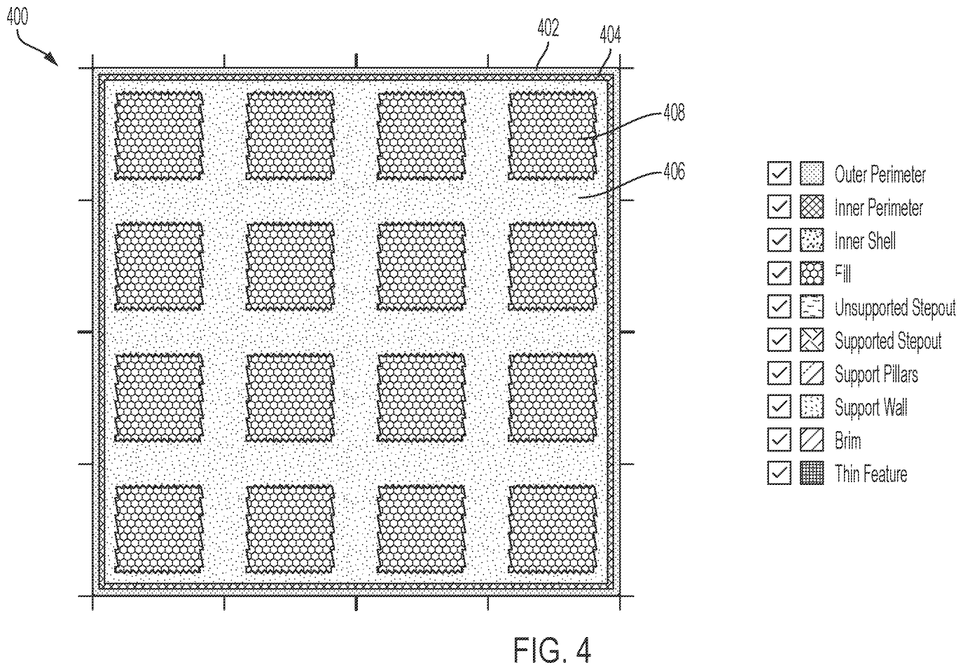

FIG. 4 depicts a top view of a typical fill pattern without the use of a sparse fill, in accordance with the present disclosure. The schematic shown in FIG. 4, exhibits a top view of the filling of the voids using a normal fill pattern prior to a bridging step and addition of one or more roof layers. In the previous example, this bridging would begin atop the 27th layer. In this fill pattern 400, it is shown where the outer perimeter 402, inner perimeter 404, support wall of the sparse infill pattern 406, and fill portion 408 shown in the top view.

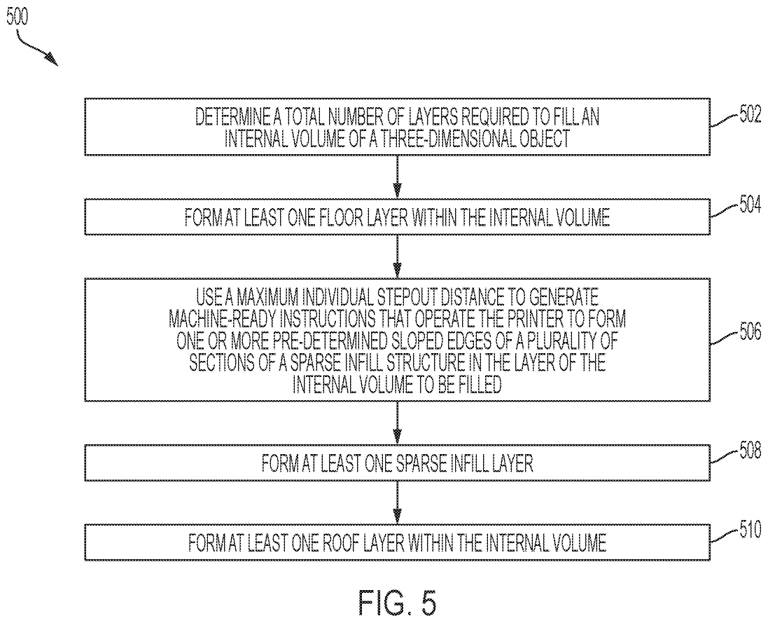

FIG. 5 illustrates a flowchart of a method for producing a sparse fill of an interior volume of a 3D object, in accordance with the present disclosure. The method of operating a printer to fill an internal volume of a three-dimensional object 500 includes determining a total number of layers required to fill an internal volume of a three-dimensional object 502, followed by forming at least one floor layer within the internal volume 504. Next, the printer operates to use a maximum individual stepout distance to generate machine-ready instructions that operate the printer to form one or more pre-determined sloped edges of a plurality of sections of a sparse infill structure in the layer of the internal volume to be filled 506, form at least one sparse infill layer 508, and form at least one roof layer within the internal volume 510. In examples, the number of floor layers is the same as the number of roof layers. It should be noted that depending on the design of the particular three-dimensional object, the number of floor layers and the number of roof layers may be different. The method of operating a printer to fill an internal volume of a three-dimensional object 500 can include where each sloped edge comprises no support material. In examples, these sloped edges each have a sloped edge angle is from 15 degrees to 75 degrees. In examples, the sloped edge angle is 30 degrees or 60 degrees. The method of operating a printer to fill an internal volume of a three-dimensional object 500 may include where each of the plurality of sections of the infill structure has a lateral dimension of from about 5 mm to about 30 mm, and in examples, can be 10 mm. In other examples of the method of operating a printer to fill an internal volume of a three-dimensional object 500 the operating instructions provided to the printer controller can include setting a number of floor layers to n, and setting a number of roof layers to n. This is followed by examples where a number of sparse infill layers not comprising the floor layers, or the roof layers is determined by subtracting 2n from the total number of layers. In some examples, the print material, and therefore the layers required to fill an internal volume of a three-dimensional object comprise a metal, a metallic alloy, or a combination thereof.

The present teachings provide an improved infill for an additively manufactured part. The sparse fill is formed when metal is extruded in a lattice-type structure instead of regular 3D printed layers, such as found in a solid infill. This results in segments of a 3D metal part being almost hollow, but with the support needed to retain strength and rigidity. The sparse fill style only effects the interior volume of a 3D part, but the exterior appears the same as solid fill part. Benefits of this sparse fill include reduced build time, reduced part cost, due to reduced material use, and reduced weight. Sparse fill can be used for large scale parts having large interiors where a three-dimensional part can benefit from being lighter.

While the present teachings have been illustrated with respect to one or more implementations, alterations and/or modifications may be made to the illustrated examples without departing from the spirit and scope of the appended claims. For example, it may be appreciated that while the process is described as a series of acts or events, the present teachings are not limited by the ordering of such acts or events. Some acts may occur in different orders and/or concurrently with other acts or events apart from those described herein. Also, not all process stages may be required to implement a methodology in accordance with one or more aspects or embodiments of the present teachings. It may be appreciated that structural objects and/or processing stages may be added, or existing structural objects and/or processing stages may be removed or modified. Further, one or more of the acts depicted herein may be carried out in one or more separate acts and/or phases. Furthermore, to the extent that the terms “including,” “includes,” “having,” “has,” “with,” or variants thereof are used in either the detailed description and the claims, such terms are intended to be inclusive in a manner similar to the term “comprising.” The term “at least one of” is used to mean one or more of the listed items may be selected. Further, in the discussion and claims herein, the term “on” used with respect to two materials, one “on” the other, means at least some contact between the materials, while “over” means the materials are in proximity, but possibly with one or more additional intervening materials such that contact is possible but not required. Neither “on” nor “over” implies any directionality as used herein. The term “conformal” describes a coating material in which angles of the underlying material are preserved by the conformal material. The term “about” indicates that the value listed may be somewhat altered, as long as the alteration does not result in nonconformance of the process or structure to the illustrated embodiment. The terms “couple,” “coupled,” “connect,” “connection,” “connected,” “in connection with,” and “connecting” refer to “in direct connection with” or “in connection with via one or more intermediate elements or members.” Finally, the terms “exemplary” or “illustrative” indicate the description is used as an example, rather than implying that it is an ideal. Other embodiments of the present teachings may be apparent to those skilled in the art from consideration of the specification and practice of the disclosure herein. It is intended that the specification and examples be considered as exemplary only, with a true scope and spirit of the present teachings being indicated by the following claims.

What is claimed is:

1. A method of operating a printer to fill an internal volume of a three-dimensional object, comprising:
determining a total number of layers required to fill an internal volume of a three-dimensional object;
forming at least one floor layer within the internal volume;
using a maximum individual stepout distance to generate machine-ready instructions that operate the printer to form one or more pre-determined sloped edges of a plurality of sections of a sparse infill structure in the layer of the internal volume to be filled;
forming at least one sparse infill layer; and
forming at least one roof layer within the internal volume; and
wherein the number of floor layers is the same as the number of roof layers.

2. The method of operating a printer to fill an internal volume of a three-dimensional object of claim 1, wherein each sloped edge comprises no support material.

3. The method of operating a printer to fill an internal volume of a three-dimensional object of claim 1, wherein each sloped edge angle is from 15 degrees to 75 degrees.

4. The method of operating a printer to fill an internal volume of a three-dimensional object of claim 1, wherein each sloped edge angle is 30 degrees.

5. The method of operating a printer to fill an internal volume of a three-dimensional object of claim 1, wherein each sloped edge angle is 60 degrees.

6. The method of operating a printer to fill an internal volume of a three-dimensional object of claim 1, wherein each of the plurality of sections of the infill structure has a lateral dimension of from about 5 mm to about 30 mm.

7. The method of operating a printer to fill an internal volume of a three-dimensional object of claim 1, wherein each of the plurality of sections of the infill structure has a lateral dimension of 10 mm.

8. The method of operating a printer to fill an internal volume of a three-dimensional object of claim 1, further comprising:
setting a number of floor layers to n; and
setting a number of roof layers to n.

9. The method of operating a printer to fill an internal volume of a three-dimensional object of claim 8, wherein a number of sparse infill layers not comprising the floor layers or the roof layers is determined by subtracting 2n from the total number of layers.

10. The method of operating a printer to fill an internal volume of a three-dimensional object of claim 1, wherein the layers required to fill an internal volume of a three-dimensional object comprise a metal, a metallic alloy, or a combination thereof.

11. A drop ejecting apparatus, comprising:
a reservoir configured to receive and melt a print material;
an ejector having a nozzle that is fluidly connected to the reservoir to receive melted print material from the reservoir;
a platform positioned opposite the ejector;
at least one actuator operatively connected to at least one of the platform and the ejector, the at least one actuator being configured to move the at least one of the platform and the ejector relative to one another; and
a controller operatively connected to the reservoir, the ejector, and the at least one actuator, the controller being configured to:
form at least one floor layer within an internal volume;
use a maximum individual stepout distance to generate machine-ready instructions that operate the apparatus to form one or more pre-determined sloped edges of a plurality of sections of a sparse infill structure in the layer of the internal volume to be filled;
form at least one sparse infill layer; and
form at least one roof layer within the internal volume.

12. The drop ejecting apparatus of claim 11, wherein the number of floor layers is the same as the number of roof layers.

13. The drop ejecting apparatus of claim 11, wherein the print material comprises a metal, a metallic alloy, or a combination thereof.

14. The drop ejecting apparatus of claim 11, wherein each sloped edge comprises no support material.

15. The drop ejecting apparatus of claim 11, wherein each sloped edge angle is from 15 degrees to 75 degrees.

16. The drop ejecting apparatus of claim 11, wherein each sloped edge angle is 30 degrees.

17. The drop ejecting apparatus of claim 11, wherein each sloped edge angle is 60 degrees.

18. The drop ejecting apparatus of claim 11, wherein each of the plurality of sections of the infill structure has a lateral dimension of from about 5 mm to about 30 mm.

19. The drop ejecting apparatus of claim 11, wherein the controller is further configured to:
set a number of floor layers to n; and
set a number of roof layers to n.

20. The drop ejecting apparatus of claim 19, wherein a number of sparse infill layers not comprising the floor layers or the roof layers is determined by subtracting 2n from the total number of layers.
